(19) United States
(12) Patent Application Publication
(10) Pub. No.: US 2009/0177847 A1
(43) Pub. Date: Jul. 9, 2009

(54) SYSTEM AND METHOD FOR HANDLING OVERFLOW IN HARDWARE TRANSACTIONAL MEMORY WITH LOCKS

(75) Inventors: Luis H. Ceze, Urbana, IL (US); Christoph von Praun, Briarcliff Manor, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/971,511

(22) Filed: Jan. 9, 2008

(51) Int. Cl. G06F 12/00

(52) U.S. Cl. 711/152; 711/E12.001

(57) ABSTRACT

A system, method and computer program product for processing overflow transactions in a transactional memory system. The transactional memory system is provided in a multiprocessing system having one or more processor devices and a shared memory storage system, and implements a best effort hardware transactional memory system. The method includes acquiring, by a requesting processor, lockbits associated with a memory structure of the shared memory storage system to be reserved for an overflowing transaction. The lockbits determine the granularity at which memory reservations for an overflow transaction are recorded. The method includes implementation of control mechanism for controlling concurrency between overflowing and non-overflowing transactions requested by processor devices in the multiprocessing system, the method enabling only one overflowing transaction to execute at a time in the multiprocessing system.

### BACKGROUND OF THE INVENTION

1. Field of the Invention

The present invention generally relates to memory architectures in computer systems and, more particularly, to a system and method for supporting transactional memory.

2. Description of the Prior Art

Atomic transactions have been widely used in parallel computing and transaction processing. An atomic transaction generally refers to the execution of multiple operations, such that the multiple operations appear to be executed together without any intervening operations. For example, if a memory address is accessed within an atomic transaction, the memory address should not be modified elsewhere until the atomic transaction completes. Thus, if a processor (or a thread in a multithreading environment) uses an atomic transaction to access a set of memory addresses, the atomic transaction semantics should guarantee that another processor (or another thread) cannot modify any of the memory addresses throughout the execution of the atomic transaction.

Atomic transactions can be implemented at architecture level via architecture and micro-architecture support, rather than at software level via semaphores and synchronization instructions. Architecture-level atomic transactions can potentially improve overall performance using speculative executions of atomic transactions as well as elimination of semaphore uses. Supporting atomic transactions architecturally often requires expensive hardware and software enhancements, such as large on-chip buffers for data of uncommitted atomic transactions, and software-managed memory regions for on-chip buffer overflows. Various architecture mechanisms supporting atomic transactions have been proposed. Architecture support of atomic transactions needs to provide conflict detection between atomic transactions, and data buffering for uncommitted transactional state. Conflict between different atomic transactions accessing same memory locations is usually detected by hardware on-the-fly. This can be achieved with reasonable implementation cost and complexity because the underlying cache coherence mechanism of the system can be used. However, it can be quite challenging to buffer data for uncommitted transactions with reasonable cost and complexity, if an atomic transaction can modify a large number of memory locations that cannot fit in an on-chip buffer (a dedicated buffer, on-chip L1/L2 caches, or a combination of both).

Existing architecture support of atomic transactions either requires that an atomic transaction ensure buffer overflow cannot happen, or fall back to some software solution when buffer overflow happens. The first approach inevitably limits the use of atomic transactions. The second approach often requires software to acquire some semaphore such as a global lock (that protects the whole address space) to ensure atomicity of memory accesses. The approach that falls back to a global lock in the event of buffer overflow inevitably limits concurrency since the lack of fine-granular tracking of read and write sets requires that all transactions (not only the overflowing one) acquire the same lock.

One prior art reference in particular entitled “801 storage: Architecture and Programming” in ACM Transactions on Computer Systems (TOCS), Vol. 6, pages 28-50, 1988 to A. Chang, et al. describes a storage system architecture that maintains lock-information in the page table entries to record the activity of transactions on different regions of memory and to facilitate conflict resolution. However, in this teaching, speculative state is virtualized and consequently there is no distinction of overflow and non-overflow case. Further, the speculative data is held in main memory and the non-speculative data is held on disk. The lockbits implemented are used as reservation mechanism for several concurrent transactions, not just by a single overflowing transaction.

It would be highly desirable to provide a mechanism for handling the case of transaction state overflow in hardware-based transactional memory systems.

### SUMMARY OF THE INVENTION

The present invention is directed to a novel transactional memory support system for handling memory-based atomic operations for processors in a multiprocessing environment.

In one aspect, the present invention is directed to a novel transactional memory support system for handling buffer overflow conditions using a lock in hardware-based transactional memory systems.

More particularly, the system and method of the present invention provides a solution that improves the situation by not requiring that a transaction execution be serialized in the event of buffer-overflow. When a transaction encounters a buffer-overflow, a fine-granular, hardware-supported locking mechanism is used to reserve memory locations that are accessed by the overflowing transaction. The operation of concurrent, non-overflowing transactions is minimally affected.

Furthermore, the system and method of the present invention facilitates the execution of non-revocable operations such as I/O during a transaction. The handling of non-revocable operations includes establishing the guarantee that a transaction can commit before executing the non-revocable operation.

Furthermore, in accordance with the present invention, the use of a fine-granular, hardware-supported locking mechanism facilitates the execution of a non-revocable operation inside a transaction without restricting execution of ordinary revocable memory access operations in concurrent transactions.

Thus, in accordance with one aspect of the invention, there is provided a system, method and computer program product for processing overflow transactions in a hardware-based transactional memory system. The transactional memory system is provided in a multiprocessing system having one or more processor devices and a shared memory storage system, and implements a best effort hardware transactional memory system. The method includes a locking means enabling the acquiring, by a processor device, of lockbits associated with a memory structure of said shared memory storage system to be reserved when a transaction transits from a non-overflow to an overflow mode or is already in overflow mode. The lockbits determine the granularity at which memory reservations for an overflow transaction are recorded. The method includes a control mechanism for controlling concurrency between overflowing and non-overflowing transactions requested by processor devices in the multiprocessing system, the method enabling only one overflowing transaction to execute at a time in the multiprocessing system.

Further to this aspect of the invention, the lockbits are acquired by a processor device at the time of a transactional read or write operation executed by an overflow transaction.

Additionally, the method ensures that a status of an overflowing transactions' read-set and write set status are validated prior to acquiring the lockbits.

According to the invention, a lockbit field including the lockbits associated with said memory structure are provided in a page table entry used for translating a virtual address to a physical address.

According to a further aspect of the invention, the lockbits specify a granularity at which memory reservations for an overflow transaction are recorded.

Further to this aspect of the invention, the controlling of concurrency between overflowing transactions in the multiprocessing system comprises:

setting an overflow flag associated with a processor device when that processor device transits to a transaction overflow mode; and,

when a processor device desires to transit to a transaction overflow mode, determining whether any other the processor device in the multiprocessor system is in or about to transit to an overflow transaction state, and,

preventing the processor device from transiting to the overflow transaction state when it is detected that another the processor device is in the multiprocessor system is in or about to transit to an overflow transaction state

Furthermore, the lockbits are inspected for detecting memory access conflicts between overflowing and non-overflowing transactions by processor devices. A memory access conflict occurs when transactions request concurrently access to the same memory address and at least one access is a write.

Furthermore, an overflow flag includes a system overflow flag indicating any processor in said system transiting to or in a overflow mode, each processor executing non-transactional memory access operations first checks said system overflow flag and a lockbit for a requested memory address prior to accessing a memory location associated with that address for a memory operation.

Furthermore, the preventing comprises delaying a processor's non-transactional memory access operation until said system overflow flag and acquired lockbits for that requested memory location are cleared.

The present invention is advantageously employed in a multiprocessing computer system, which may be implemented in System-on-Chip integrated circuit designs having a plurality of processor devices each for access a shared memory structure, however, can easily be adapted for use in other types of multiprocessor computing systems.

### BRIEF DESCRIPTION OF THE DRAWINGS

The objects, features and advantages of the present invention will become apparent to one skilled in the art, in view of the following detailed description taken in combination with the attached drawings, in which:

FIG. 1 is a diagram of a computing system environment in which the present invention operates;

FIG. 2 is a diagram depicting the components for handling transaction state overflow in hardware-based transactional memory system 200 of the present invention;

FIG. 3 is a diagram depicting a one-level page table with extensions for lockbits in the page-table entries;

FIG. 4 is a diagram depicting the lockbit structure with support for locking at fine, sub-page granularity according to one embodiment of the present invention.

FIG. 5 is a diagram depicting of the extended processor status register according to one embodiment of the present invention.

FIG. 6 is a flow chart depicting the protocol that guarantees that only a single processor acquires privilege to continue execution of an overflowing transaction according to one embodiment of the present invention.

FIG. 7 is a flow chart depicting the transition of a processor from non-overflow to the overflow mode according to one embodiment of the present invention.

FIG. 8 is a flow chart depicting transactional load and store memory access operations according to one embodiment of the present invention.

FIG. 9 is a flow chart depicting non-transactional load memory access operation according to one embodiment of the present invention.

FIG. 10 is a flow chart depicting a non-transactional store memory access operation according to one embodiment of the present invention.

FIG. 11 is a flow chart depicting a transaction commit operation according to one embodiment of the present invention.

### DETAILED DESCRIPTION OF THE PREFERRED EMBODIMENTS

The present invention proposes a new mechanism to handle the case of transaction state overflow in best effort hardware-based transactional memory systems (BET). The invention utilizes the mechanisms for read-set, write-set tracking and buffering of the BET system in the case of non-overflowing transactions and uses a combination of said mechanisms with per memory reservation structures (lockbits, e.g., at a per page or line granularity) in the event of transaction overflow. Reservations (lockbits) are used to control concurrency and conflict detection between the overflowing and other non-overflowing transactions. The design permits at most one overflowing transaction.

The cost of overflow is largely paid by the transaction that overflows. Cost incurred for concurrent non-overflowing transactions are twofold: (i) check of lock bits at load, store access, (ii) polite conflict management (non-overflowing transactions steps back in favor of an overflowing transaction).

The proposed invention is an extension to the following technology: 1) A best-effort hardware transactional memory system (BET); 2) An invalidation-based cache coherence protocol. Such protocol is required to enable overflowing transaction to acquire ownership of data read and written by non-overflowing transactions; and, 3) A mechanism for tracking fine-granular, precise reservations for contiguous sections or memory (lockbits). In one embodiment, it is assumed that such reservation functionality is implemented as an extension of the memory address translation mechanism, i.e., as extension of the page table and associated caching structures. The caching structures are associated with individual processors and enable efficient access to page table entries by said processor. An implementation of such address translation cache is, for example, a translation lookaside buffer (TLB). When implementing the present invention, a TLB entry includes the same extension as the page table entries, i.e., the lockbit field as shown and described with reference to FIG. 4.

Besides handling transaction overflow, the proposed invention facilitates execution of non-revocable operations, e.g. I/O, inside transactions, e.g., by forcing a transaction to overflow mode when a non-revocable operation is requested. The rational behind this mechanism is that a transaction that executes in overflow mode is guaranteed to execute successfully to completion (commit).

Embodiments of the present invention include, inter alia, (i) use of a cache-based best effort transactional memory system to handle non-overflowing transactions, (ii) use of a reservation-based mechanism, herein referred to as “lockbits”, to handle overflow case, (iii) a mechanism that guarantees that there is at most one overflowing transaction in a multiprocessor system, and (iv) a mechanism that establishes reservations at the time of transaction overflow through a traversal of the transaction buffer of the overflowing transaction.

One aspect of the present invention that extends the use of a cache-based best effort transactional memory system to handle non-overflowing transactions, is now described. In accordance with this aspect, as shown in FIG. 2, a “Best Effort” type Transactional memory system (BET) is shown that includes a transactional memory system 200 that records transactional read and write operations in finite storage on or close to the processor core indicated as processor core 201, having one or more processing units 202. This storage, shown in FIG. 2, is referred to as a transactional buffer 207 that may be part of or associated with a processor cache memory 204, but this is not required. The size of the storage is typically orders of magnitude smaller than the available physical memory 205 available in the system. Load and store operations that execute in the context of a transaction specified by a software thread 203 executing in the processing units 202 are recorded as follows: For a read operation, the location or a superset approximation is recorded. For a write operation, the location as well as the current or speculative value, is recorded, depending on the write policy of the transactional memory system. The transactional memory system is not able to handle transactions that exceed the size of the transactional buffer 207 or request execution of a non-revocable operation such as I/O, hence “best effort” transactions.

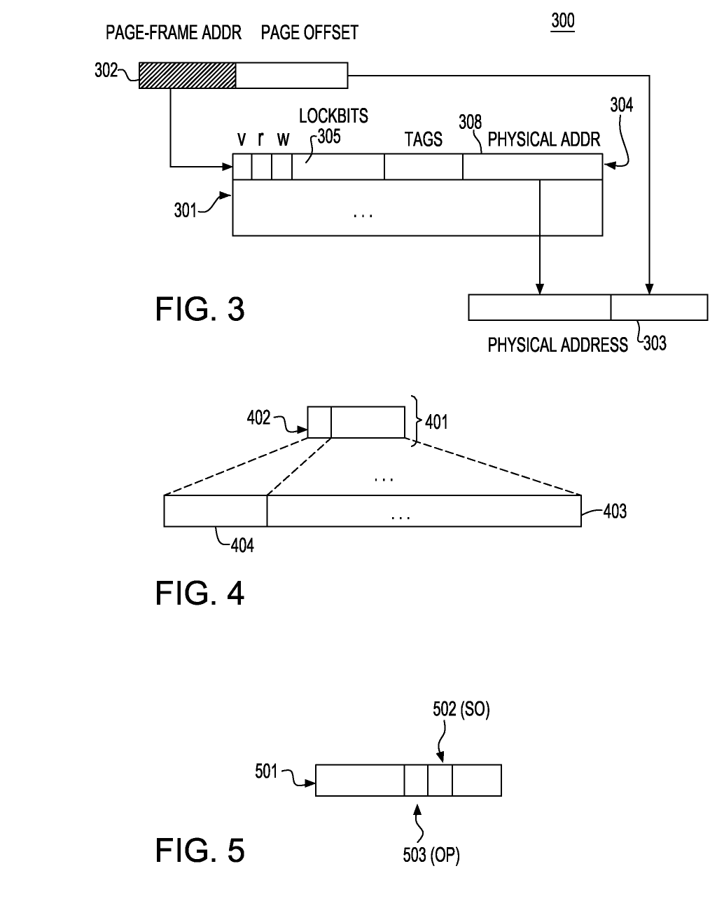

A further aspect of the present invention that extends the use of a reservation-based mechanism, herein referred to as “lockbits”, to handle the overflow case, is now described with respect to FIG. 3. FIG. 3 is a schematic diagram 300 depicting a one-level page table with extensions for lock information (lockbits) in the page-table entries 304. In this embodiment, the reservation information is associated with address translation information stored in the page table 301 illustrated in FIG. 3. The page table 301 serves to translate virtual memory addresses 302 to physical memory addresses 303. The translation operation matches the page frame address portion of the virtual address 302 with a tag 308 in the page table entry 304 that provides the physical address portion corresponding to the virtual address tag and additional information about the memory page, such as read/write/valid status and the lockbits 305 used in the present invention.

With reference now had to FIG. 4, there is depicted a lockbit field 401 that is provided with each per page table entry 304 (of FIG. 3). The lockbit field 401 includes a number of bits, e.g., “k” bits 402, with k>0, that determine the granularity at which memory reservations can be recorded. The value of a bit specifies if the corresponding fraction 404 of the page 403 is reserved for the overflowing transaction or not. For example, assuming that the lockbit field is 16 bits wide, and a page table entry corresponds to memory block of 4096 bytes. Then the lock featured by bit k in the lockbit field of the page table entry protects the address range of bytes (k−1)*4096 to k*4096−1 within that page. FIG. 4 depicts a lockbit for locking a fraction 404 of a page table entry, i.e., for locking at sub-page granularity (e.g., at a granularity corresponding to the cache line size, typically 128 bytes, or finer). Lockbits are set as transactional read and write operations are executed by an overflowing transaction operation. Lockbits are cleared after an overflowing transaction commits.

A further aspect of the present invention that guarantees that there is at most one overflowing transaction in a multiprocessor system, is now described. Particularly, when two or more transactions in the system overflow simultaneously, one of the transactions is aborted. Limiting the use of the lock-based overflow mechanism to a single processor ensures absence of deadlock. It is understood that more sophisticated policies, like blocking, are also possible. The present invention thus includes a mechanism that can establish consensus among all processors such that only a single processor at a time is processing a transaction in overflow mode. A description of the architectural extensions and protocols that achieve this functionality is now described with respect to FIG. 5.

In one embodiment of the invention, information about the overflow status of a transaction is specified by the processor status register (PSR) 501, as illustrated in FIG. 5. The PSR is a per processor resource and, according to the invention, is extended with two bits: 1) an overflow pending bit (OP) 503 that is set when at least one processor in the system is overflowing; and, 2) a system overflow (SO) bit 502 that is set if some processor caused the system to transit in overflow mode. Both, the SO and OP bit are set at the same time if the current processor is in overflow mode.

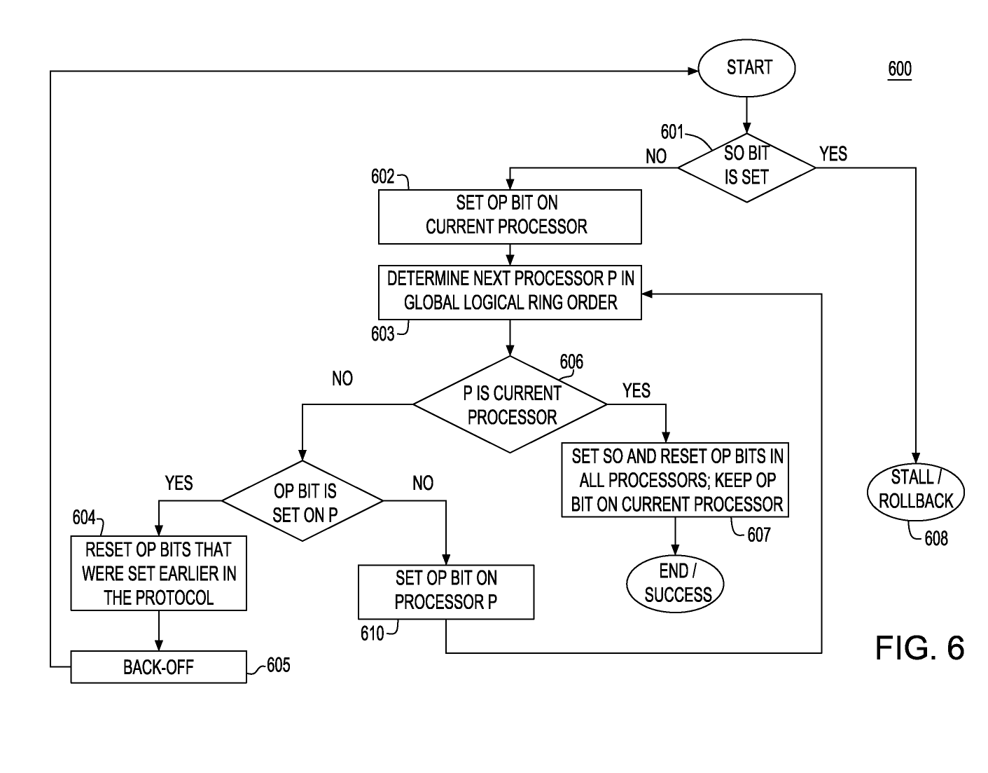

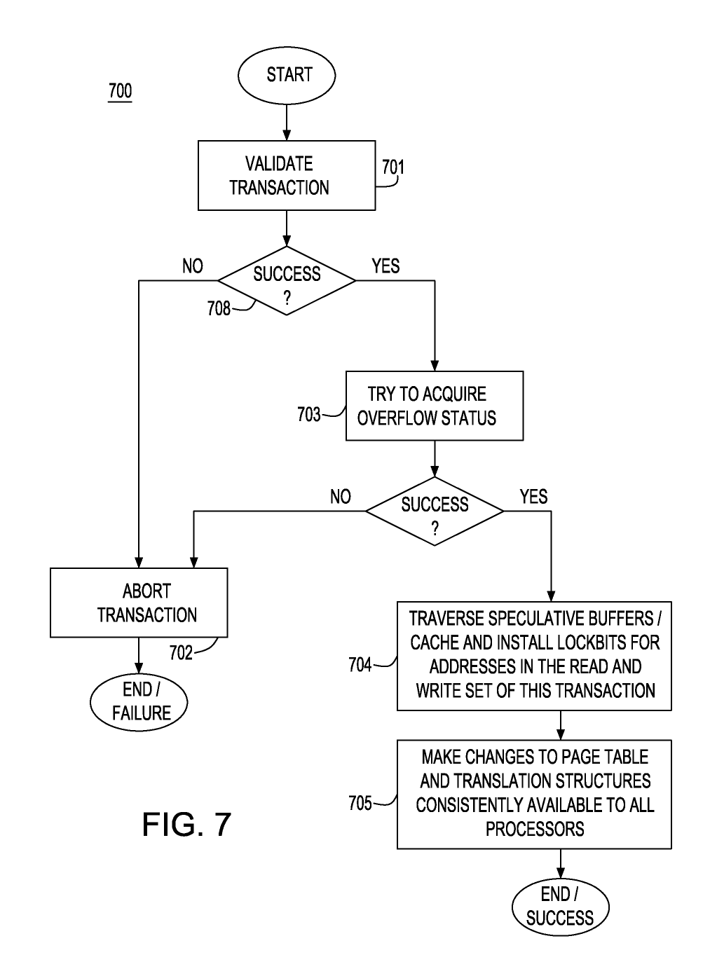

FIG. 6 is a flow chart depicting an example protocol 600 implemented to ensure that only a single processor overflows at a time. In this example embodiment, the protocol illustrated in FIG. 6 ensures that only a single processor in a multiprocessor system acquires the privilege to continue its transaction in the event of overflow. As a result of the successful transition to overflow mode, the processor set its SO and PO bits in its PSW. The protocol requires that processors are totally ordered on a logical ring. The protocol proceeds as follows: First, a processor “Q” that desires to process a transaction in overflow mode checks if the system is already in overflow mode by inspecting the state of the SO bit in its PSR as indicated at 601. If, as determined at step 601, the SO bit is set, then some other transaction in the system executes in overflow mode; a possible way to handle this situation is to stall the processor, e.g., as indicated at step 608, until the bit is cleared and then proceed with the protocol according to 602. Alternatively, the transaction could roll-back and retry execution at step 608. Returning to step 601, if it is determined that the SO bit is not set, the processor starts a consensus protocol with other processors as follows: It sets the OP bit in its PSR at step 602. Then, at step 603, the processor tries to set the OP bit in every other processors P if it is not already set. This is attempted for each processor in the total order of processors. If a processor P is encountered where OP is set, and P≠Q as determined at step 606, then another processor tries to concurrently acquire overflow status and the protocol initiates resetting of all previously set OP bits at step 604, backs-off at step 605, and, retries the overall protocol by returning to step 601. If processor Q succeeded to set the OP bit in all processors, Q has successfully acquired overflow status at step 606, and sets the SO bit on all processors and resets the other processor's OP bits as indicated at 607.

A further aspect of the present invention that establishes reservations at the time of transaction overflow through a traversal of the transaction buffer of the overflowing transaction in a multiprocessor system, is now described with respect to FIG. 7. Particularly, FIG. 7 illustrates an algorithm 700 governing the transition to the overflow mode. Particularly, at step 701, at the time of overflow, a transaction validates its read-set, i.e., it determines if concurrent transaction have updated locations that have been read by the current transaction. As determined at step 708, if this is not the case, or those concurrent transactions have not yet committed, the validation is successful which means that the transaction could commit at the current point of execution. If validation is unsuccessful, as determined at step 708, then the transaction aborts 702. If validation is successful then the overflowing processor engages in a consensus protocol to acquire overflow status in a multiprocessor system 703. Further details regarding this consensus protocol is described in greater detail herein with respect to FIG. 6. If the processor cannot acquire global overflow status, then the transaction aborts 702. Otherwise, if the processor acquires global overflow status, then information about speculative read and write operations recorded in the transactional buffer 207 is traversed as indicated at 704 and the appropriate reservations (lockbits) 305 in the page table 301 (FIG. 3) are acquired at 704. Thus, lockbits are acquired only when a transaction transits from non-overflow to overflow mode. Since only a single processor can acquire global overflow status, there is no race when accessing the lockbits in the page table and all lockbits are found clear (unreserved). Continuing, after update, the lockbit information must be made available to other processors in the system as indicated at 705; invalidation of address translation caches in other processors may be necessary. After successfully installing the lockbits, the overflowing transaction is guaranteed to be able to commit.

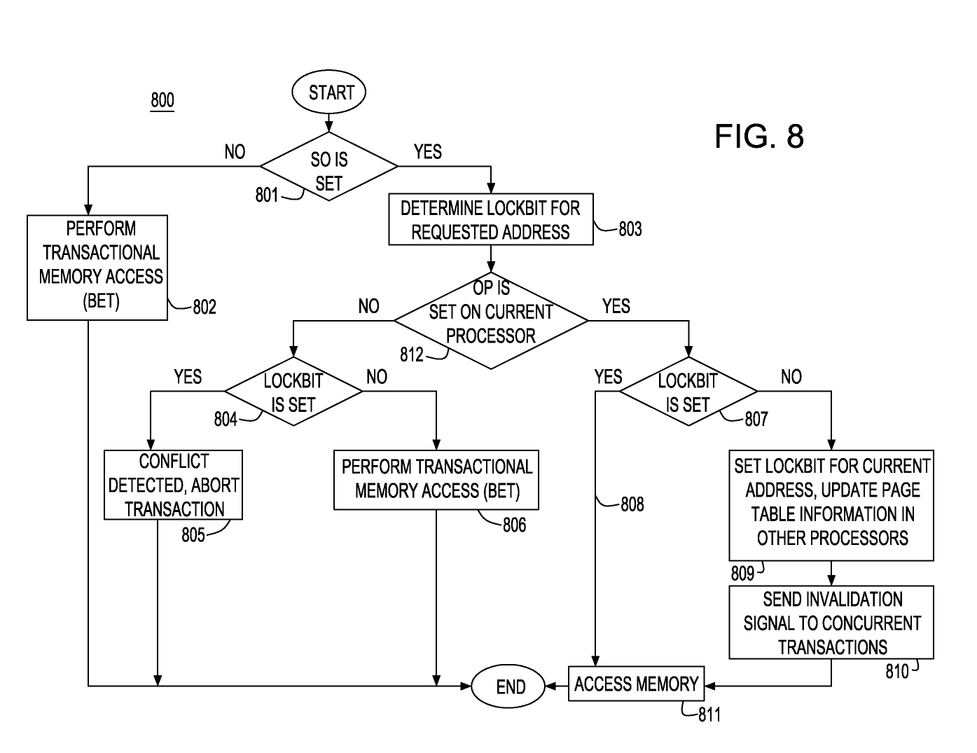

Details regarding the protocol 800 for transaction memory access load and store operations in accordance with the invention are illustrated in FIG. 8. Transactional load and store operations—whether executed by an overflowing or regular transaction—performs a check as to whether there is some overflowing transaction in the system 801. This check is facilitated by the SO bit 502 as indicated in the PSR 501 shown in FIG. 5. If the SO bit is not set, access proceeds according to the principles of the underlying best effort transactional memory system 802. Otherwise, the state of the lockbit corresponding to the address is determined at step 803. If the accessing processor does not execute in overflow mode 804 as determined by the OP bit at 812, access to a locked location causes transaction abort 805, i.e., the lockbit is set; otherwise, if the lockbit is not set at 812, the hardware transaction access proceeds normally as indicated at 806. If the accessing processor executed in overflow mode (OP bit set), one of two cases are possible. If the lockbit is set as determined at step 807, then the access can proceed normally as indicated at 808 to perform a regular memory access at step 811; if the lockbit is not set as determined at step 807, then the lockbit is set in the page table and corresponding address translation structures and the changes are propagated to all other processors in the system as determined at 809. Further, the invalidation of address translation caches in other processors may be necessary. Invalidations are sent to concurrent (non-overflowing) transactions that must abort if they accessed the same location (eager conflict detection in the overflow case) 810. Finally, a regular memory access is issued 811. As readily seen, lockbits are inspected and used only in the case there is an overflowing transaction active in the system.

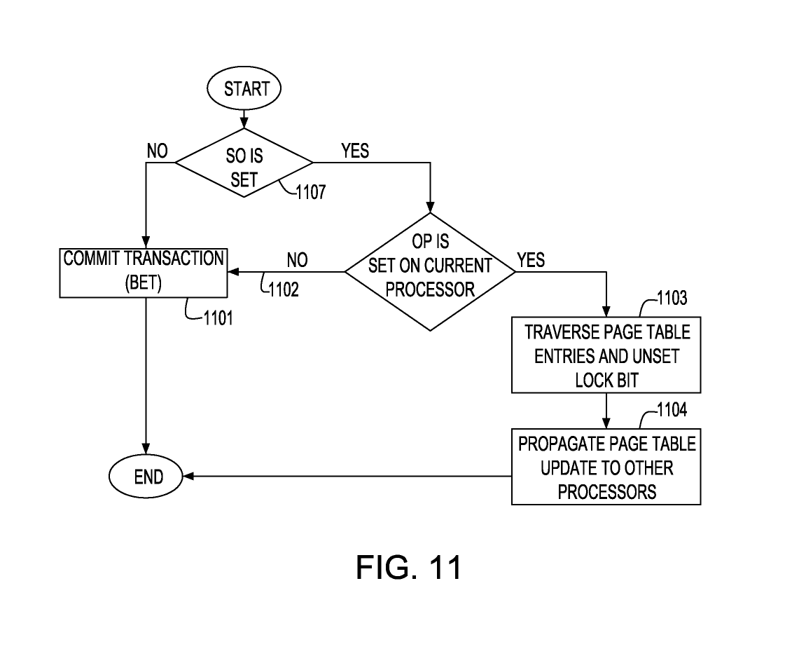

FIG. 11 is a flow chart depicting a transaction commit operation according to one embodiment of the present invention. For a transaction in non-overflow mode as determined by the SO bit at 1107, transaction commit is unchanged, i.e., the implementation corresponds to commit in the underlying best effort transactional memory systems 1101. The same applies if some processor other than the current one operates in overflow mode as indicated at 1102. A transaction in overflow mode is committed by releasing the lockbits corresponding to addresses in the read and write set of the transaction 1103. The changes to the page table must be made available to other processors in the system 1104; invalidation of address translation caches in other processors may be necessary.

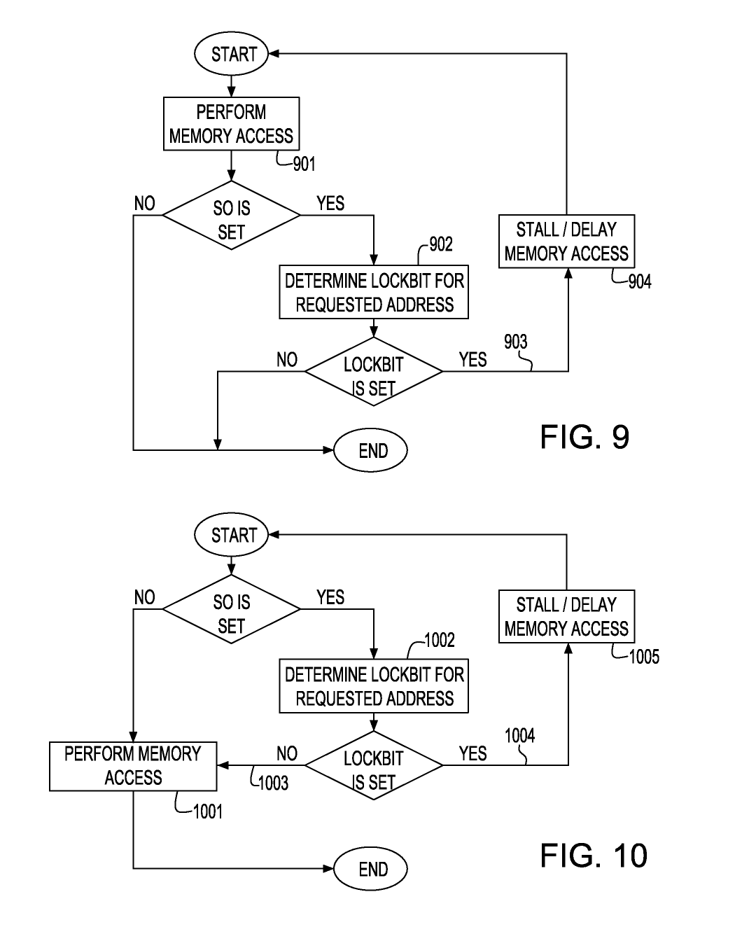

The mechanism of overflow handling described in this disclosure can maintain strong atomicity semantics if the underlying best effort transactional memory system does so. Such mechanism is as described in the reference to C. Blundell, Ch. Lewis and M. Martin, Milo entitled “Deconstructing Transactions: The Subtleties of Atomicity”, Fourth Annual Workshop on Duplicating, Deconstructing, and Debunking, June, 2005, the whole contents and disclosure of which is incorporated by reference as if fully set forth herein. Strong atomicity means that atomicity and isolation guarantees of a transaction are not only guaranteed with respect to other transactions but also with respect to concurrent non-transactional memory access. To support strong atomicity semantics, the method of non-transactional memory access should be extended as illustrated in FIGS. 9 and 10.

FIG. 9 particularly illustrates the protocol 900 for a non-transactional load operation: First, the memory access is performed 901. If the system operates in overflow mode as determined by a SO bit set and after determining the lockbit of the requested address at 902, if it is determined that the lockbit of the accessed address is set at 903, then the load must be stalled 904 and the access must be reissued once the lockbit is found to be cleared.

The situation is slightly different for a store access as illustrated in FIG. 10. FIG. 10 is a flow chart depicting a non-transactional store memory access operation according to one embodiment of the present invention. If the system does not operate in overflow mode as determined by a SO bit not being set, the store access proceeds normally (as in with best effort transactions) as indicated at 1001. In overflow mode (SO bit set) and after determining the lockbit of the requested address at 1002, if it is determined that the lockbit of the accessed address is not set (e.g., the lockbit is cleared) at 1003 then the store operation occurs in an atomic step 1001 to avoid a race condition with an access performed by the overflowing transaction. If it is determined that the lockbit of the accessed address is set at 1004, then the store operation must be delayed as indicated at 1005 to respect the isolation requirements of the concurrent overflowing transaction.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

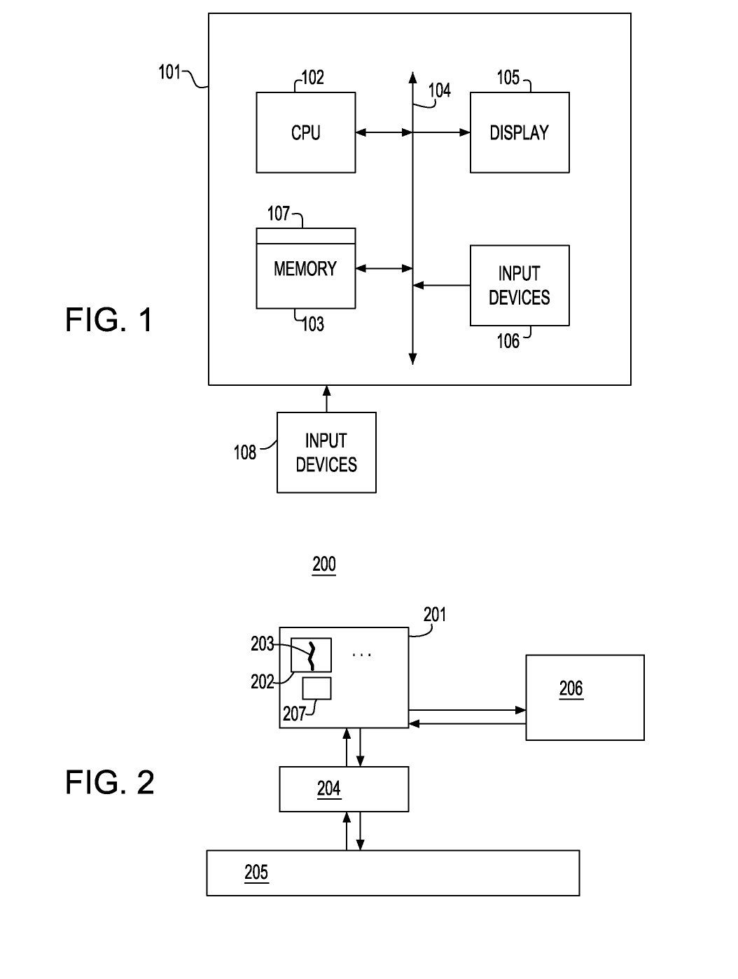

Referring to FIG. 1, according to an embodiment of the present invention, a computer system 101 Implementing the present invention comprises, inter alia, a central processing unit (CPU) 102, a memory 103 and an input/output (I/O) interface 104. The computer system 101 is generally coupled through the I/O interface 104 to a display 105 and various input devices 106 such as a mouse and keyboard. The support circuits can include circuits such as cache, power supplies, clock circuits, and a communications bus. The memory 103 can include random access memory (RAM), read only memory (ROM), disk drive, tape drive, or a combination thereof. The present invention can be implemented as a routine 107 that is stored in memory 103 and executed by the CPU 102 to process the signal from the signal source 108. As such, the computer system 101 is a general-purpose computer system that becomes a specific-purpose computer system when executing the routine 107 of the present invention.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described our invention, what we claim as new, and desire to secure by Letters Patent is:

1. A system for processing overflow transactions in a hardware-based transactional memory system provided in a multiprocessing system having one or more processor devices and a shared memory storage system, said system comprising:
locking means enabling the acquiring, by a processor device, of lockbits associated with a memory structure of said shared memory storage system to be reserved when a transaction transits from a non-overflow to an overflow mode or is already in overflow mode; and,
means for controlling concurrency of overflowing transactions when requested by processor devices in said multiprocessing system such that only one overflowing transaction to execute at a time in said multiprocessing system.

2. The system as claimed in claim 1, wherein said lockbits are acquired by a processor device at the time of a transactional read or write operation executed by an overflow transaction.

3. The system as claimed in claim 2, further comprising, means for validating a status of an overflowing transactions' read-set and write set status prior to acquiring said lockbits.

4. The system as claimed in claim 1, further including a lockbit field including said lockbits associated with said memory structure, said lockbit field provided in a page table entry used for translating a virtual address to physical addresses.

5. The system as claimed in claim 1, wherein said lockbits determine the granularity at which memory reservations for an overflow transaction are recorded.

6. The system as claimed in claim 1, wherein said lockbits reserve at a per page or finer granularity.

7. The system as claimed in claim 1, wherein said means for controlling concurrency of overflowing transactions in said multiprocessing system comprises:
means for setting an overflow flag associated with a processor device in said multiprocessing system when that processor device transits to a transaction overflow mode; and,
means for inspecting each processor device's overflow flag for detecting whether any other processor device in said multiprocessor system is in or about to transit to an overflow transaction state; and,
means responsive to said detecting for preventing said processor device from transiting to said overflow transaction state when a set overflow flag is detected by said inspecting means.

8. The system as claimed in claim 7, further comprising means for inspecting said lockbits for detecting conflicts between overflowing and non-overflowing transactions requested by processor devices in said multiprocessing system.

9. The system as claimed in claim 8, wherein an overflow flag includes a system overflow flag indicating any processor in said system transiting to or in a overflow mode, each processor executing non-transactional memory access operations first checks said system overflow flag and a lockbit for a requested memory address prior to accessing a memory location associated with that address for a memory operation.

10. The system as claimed in claim 9, wherein said means responsive to detecting a set overflow flag enables delaying of a processor's non-transactional memory access operation until said system overflow flag and acquired lockbits for that requested memory location are cleared.

11. A method for processing overflow transactions in a hardware-based transactional memory system provided in a multiprocessing system having one or more processor devices and a shared memory storage system, said method comprising:
acquiring, by a requesting processor, lockbits associated with a memory structure of said shared memory storage system to be reserved when a transaction transits from a non-overflow to an overflow mode or is already in overflow mode; and,
controlling concurrency between overflowing and non-overflowing transactions requested by processor devices in said multiprocessing system such that only one overflowing transaction to execute at a time in said multiprocessing system.

12. The method as claimed in claim 11, wherein said lockbits are acquired by a processor device at the time of a transactional read or write operation executed by an overflow transaction.

13. The method as claimed in claim 12, further comprising, validating a status of an overflowing transactions' read-set and write set status prior to acquiring said lockbits.

14. The method as claimed in claim 11, her comprising:
providing a lockbit field including said lockbits associated with said memory structure in a page table entry used for translating a virtual address to physical addresses.

15. The method as claimed in claim 11, further comprising: determining, from said lockbits, a granularity at which memory reservations for an overflow transaction are recorded.

16. The method as claimed in claim 11, wherein said controlling of concurrency between overflowing transactions in said multiprocessing system comprises:
setting an overflow flag associated with a processor device when that processor device transits to a transaction overflow mode; and,
when a processor device desires to transit to a transaction overflow mode, determining whether any other said processor device in said multiprocessor system is in or about to transit to an overflow transaction state, and,
preventing said processor device from transiting to said overflow transaction state when it is detected that another said processor device is in said multiprocessor system is in or about to transit to an overflow transaction state

17. The method as claimed in claim 16, further comprising:
inspecting said lockbits for detecting conflicts between overflowing and non-overflowing transactions requested by processor devices.

18. The method as claimed in claim 17, wherein an overflow flag includes a system overflow flag indicating any processor in said system transiting to or in a overflow mode, each processor executing non-transactional memory access operations first checks said system overflow flag and a lockbit for a requested memory address prior to accessing a memory location associated with that address for a memory operation.

19. The method as claimed in claim 18, wherein said preventing comprises delaying a processor's non-transactional memory access operation until said system overflow flag and acquired lockbits for that requested memory location are cleared.

20. A computer program storage device, readable by machine, tangibly embodying a program of instructions executable by a machine to perform method steps for processing overflow transactions in a transactional memory system provided in a multiprocessing system having one or more processor devices and a shared memory storage system, said method steps comprising:
acquiring, by a requesting processor, lockbits associated with a memory structure of said shared memory storage system to be reserved when a transaction transits from a non-overflow to an overflow mode or is already in overflow mode; and,
controlling concurrency between overflowing and non-overflowing transactions requested by processor devices in said multiprocessing system such that only one overflowing transaction to execute at a time in said multiprocessing system.
